(19) United States
(12) Patent Application Publication
(10) Pub. No.: US 2014/0351867 A1
(43) Pub. Date: Nov. 27, 2014

(54) ENTERTAINMENT NETWORK FOR PASSENGERS IN A MEANS OF TRANSPORTATION

(71) Applicant: Lufthansa Systems Ag, Kelsterbach (DE)

(72) Inventors: Peter Hommel, Bad Homburg (DE); Jörg Liebe, Wiesbaden (DE)

(21) Appl. No.: 14/359,748

(22) PCT Filed: Oct. 29, 2012
(86) PCT No.: PCT/EP2012/071386

§ 371 Date: May 21, 2014

(30) Foreign Application Priority Data
Nov. 22, 2011 (DE) 102011086830.5

(51) Int. Cl. H04N 21/414; H04N 21/41

(52) U.S. Cl. CPC H04N 21/41422; H04N 21/4126
USPC 725/75

(57) ABSTRACT

An entertainment network for passengers in a means of transportation, such as an airplane, having at least one data server for video and/or audio data. A routing device is connected to the data server. The entertainment network has at least one playback device which is provided for a passenger for the duration of a trip in order to play back the audio/video data. The routing device is designed for the wireless broadband transmission of the video/audio data to numerous playback devices simultaneously and in at least two different frequency bands independently of one another. The playback device is designed to only receive the data of a first frequency band, and a second frequency band is designed to be received only by individual passenger terminals, such as notebooks, tablets, or smartphones. The invention likewise relates to methods for transmitting audio/video data to entertain passengers in a means of transportation.

The invention relates to an entertainment network for passengers in a means of transportation, such as an aircraft, a ship, a bus or a train, for example, and to a method for transmitting video and/or audio data in order to entertain passengers in a means of transportation.

So-called in-flight entertainment systems are known in which films are transmitted to an in-seat monitor integrated in a passenger seat. The in-seat monitor is integrated in the backrest of a respective passenger seat in front. The films are stored as video data on a central data server and are transmitted via data cables when called by a passenger through an operating unit associated to the monitor. In this regard, each in-seat monitor must have its own data cable link to the data server so that the video data can be transferred individually to each in-seat monitor. For this purpose, a great number of data cables is required that are most often installed in the floor of the aircraft cabin. Especially with modern wide-body jets that have up to 600 seats, the amount of data cables required for an in-flight entertainment system is considerable and comes with corresponding weight and maintenance effort. Moreover, each live cable in an aircraft bears the potential risk of a cable fire.

Further, WLAN networks in passenger aircrafts are known that enable a passenger to establish a link to the Internet (World Wide Web) or to receive e-mails using his individual notebook, cell phone, PDA or another passenger terminal. The amount of data involved in using the Internet or in sending e-mails is a fraction of the amount of data involved in transmitting video films, e.g. by video streaming. The known WLAN networks in aircrafts are unable to transmit large amounts of data involved in transmitting films or music in a simultaneous and independent manner to a plurality of passengers. Even when Internet or e-mail services are used, a WLAN access point of the known WLAN networks in aircraft can manage only a limited number of simultaneous radio links. In view of this, the use of the known WLAN networks for transmitting video films in an in-flight entertainment system in aircraft is not feasible.

It is an object of the invention to provide a flexible and technically simplified in-flight entertainment system for passengers in a means of transportation.

The entertainment network of the present invention is defined by the features of claim 1. The present method for transmitting video and/or audio data is defined by the features of claim 7.

The entertainment network for passengers comprises at least one data server for video and/or audio data, at least one routing means connected with the data server, and at least one playback device for the playback of the video/audio data put at a passenger's disposal for the duration of the trip. The duration of the trip is understood as the duration of the stay of a passenger in a means of transportation for the purpose of transportation, i.e. the duration of a flight, for example. The routing means is configured for a wireless broadband transmission of the video/audio data to at least twenty, preferably to at least sixty participants at the same time and in at least two different frequency bands that are independent from each other. The playback devices are configured for wireless communication with the routing means and are designed to receive only the data of a first frequency band. A second frequency band is configured to be received only by individual passenger terminals notebooks, tablet PCs, cell phones, PDAs and the like.

The playback device may be fixedly allocated to a passenger seat and may comprise a seat monitor supported by a passenger seat. As an alternative or in addition, the playback devices may be portable computers, such as tablet PCs, for example, having a touchscreen, which are put at a passenger's disposal at the beginning of a trip or a flight on a lending basis for the duration of the trip or the flight. All playback devices, i.e. the devices fixedly allocated to a passenger seat and the portable devices lent to passengers, communicate with the data server per WLAN via the routing means. Contrary to the conventional principle to wire each seat monitor with the data server, the invention provides that the playback devices are in radio communication with the data server via WLAN. In this regard, the routing means is configured for wireless broadband data transmission to at least twenty, preferably at least sixty participants at the same time. In this manner, the video and/or audio data can be transmitted to a plurality of devices during a ride or a flight.

Here, the playback devices are made available to a passenger only on a lending basis so that current, newly released video films or music can be offered for playback without the risk of these data being stolen or manipulated by passengers. The transmission to the playback devices is effected in a first frequency band that differs from a second frequency band in which video and/or audio data are transmitted to passenger terminals. In this context, passenger terminals are devices owned and taken along by the passengers on which only less current films and music may be played back. For this purpose, the data server should preferably be able to distinguish between the playback devices and the passenger terminals, in order to enable a purposeful selection of the data to be transmitted by the server to the respective devices.

The passenger devices should preferably be able to communicate with the playback devices via the routing means. It is particularly advantageous, if the passenger device of a passenger is able to establish a communication link to the playback device of that passenger, which enables, for example, an operation of the playback device with the aid of the passenger device. This communication link should be established exclusively between the playback device and the respective passenger device and should not be susceptible to interference from other devices. To this end, the passenger can request the playback device to generate and display a code which is thereafter entered by the passenger into the passenger device. The code serves to uniquely identify the respective playback device with which a communication link is to be established from the side of a passenger device. Alternatively or additionally, a direct infrared link or another wireless communication link is conceivable between a passenger device and a playback device.

On the passenger terminals, the video and audio data are played back as a data stream, the data transmitted being automatically deleted instantly and irrevocably after playback, respectively. Thus, after playback, no audio or video data remain on the passenger terminal. On the playback devices, i.e. the devices fixedly allocated to a seat and having a seat monitor, and on the lent devices given to passengers on a lending basis for the duration of the trip, the data to be played back are first stored in their entirety. The transmission and storage of the data is performed preferably before the beginning of a trip. In case of a disturbance or a failure of the radio link, the data can still be played back by the playback devices. Storing the video and audio data on the playback devices is not critical because these devices are the property of the respective airline and are provided to the passengers only on a lending basis for the duration of a trip. Therefore, passengers have no possibility to steal or manipulate the stored data.

Preferably, the playback devices, i.e. the devices fixedly allocated to a seat and having a seat monitor or the lent devices, are equipped with a microphone serving to receive an acoustic signal and to automatically interrupt playback upon receipt of this signal. When transporting passengers, it is often necessary to inform the passengers about particular conditions or to request for the fastening of the seat belts, for example, via loudspeaker announcements, so-called “public announcements”. It is thus possible to interrupt the server-independent, decentralized playback of the video and audio data on the playback devices, where it is conceivable to send a two-channel sound as a signal to interrupt the playback and to send a special final sound to eventually reactivate the playback.

In addition to the server-independent, decentralized playback after the data to be played back have been stored beforehand, the playback devices should preferably also be able to playback data from the data sever as a data stream. This enables live broadcasts using, for example, cameras installed on the outer side of the means of transportation.

Moreover, it is conceivable to provide the playback devices, i.e. the devices fixedly allocated to a seat and the lent devices, with cameras or motion sensors that allow a contactless operation of the devices by automated motion detection. In this manner, a passenger can operate the device in a contactless manner by means of appropriate gestures.

Upon request by a passenger at a playback device or his own passenger terminal, the desired video and/or audio data are transmitted from the data server to the respective device. The data are transmitted from the data server to the routing means which transmits the data in the first frequency band only to the relevant playback device and transmits them to the individual passenger terminal in the second frequency band. In this regard, the routing means is configured for wireless data transmission, e.g. according to the WLAN standard IEEE 802.11n for the communication with the passenger terminals. In this context, any passenger with a typical terminal with WLAN capability can establish a link to the data server via the routing means in order to transmit the video/audio data as a data stream to his terminal and to play them back via this device. The same video/audio data can be transmitted simultaneously to different passenger terminals and to different playback devices. The transmission of the data to the playback devices in the first frequency band, which is different from the second frequency band, prevents a mutual influence on the communication between the data server and the playback device and the data server and the passenger terminal.

In this manner, it is avoided that failures of a passenger terminal interfere with the data transmission to the playback devices. Further, a possible intentional influence via a passenger terminal on the communication between the data server and the playback device is prevented.

The entertainment network of the present invention and the data transmission method of the present invention make the necessity of cable connections between a data server and playback terminals obsolete. The omission of cable connections saves weight and reduces the risk of cable fires. The passenger seats are more easy to install and to remove so that a flexible and easily variable arrangement of passenger seats in the means of transportation, e.g. in an aircraft cabin, is possible. Moreover, means of transportation, especially aircrafts, can also be retrofitted easily with the entertainment system.

Preferably, the routing means includes a WLAN router, e.g. according to the IEEE standard 802.11n for a network link to the passenger terminals. This enables a connection of the passenger terminals to the Internet and, at the same time, a broadband data transmission as a data stream of video films to a plurality of passenger terminals in a simultaneous and mutually independent manner.

The radio transmission from the routing means to the communication means of a playback device is advantageously performed in an ISM radio frequency band. An ISM (Industrial, Scientific and Medical Band) radio frequency band is a frequency band that can be used by high-frequency devices in the fields of industry, science and medicine, in the domestic and similar fields. A typical ISM radio frequency band is between 5.725 and 5.875 GHz. Typical frequency bands according to the IEEE WLAN standard 802.11n are in the range between 5.15 and 5.35 GHz or in the range from 5.47 to 5.475 GHz. These frequency bands differ from the ISM frequency band mentioned and do not influence each other. Further, a broadband data transmission in these frequency bands does not interfere with the safe progress of trip or the flight operation.

Special settings (such as Intrusion Detection, Quality of Service, bandwidth management etc.) can be made for the playback devices both in the routing means (access point) and in the communication means of the playback devices. To secure the communication between playback devices and the data server on board the means of transportation, special settings can be made that allow for a high stability and performance of the system.

Advantageously, the video and audio data are transmitted to the display device on demand, i.e. upon request by a passenger. The films are made available on the data server in the form of compressed and encoded video data. A passenger can select the video and audio contents via a web application. After the selection, the desired contents are distributed via the wireless radio net to the relevant passenger terminal as a single dedicated data stream per passenger. The data stream is decoded and displayed on the display device. A Digital Rights Management System can be used to secure the contents. In this manner, large amounts of data, as they typically exist for video films in digital form, can be transmitted chronologically independently from each other and in parallel to a large number of devices. Specifically in modern wide-body jets with up to 600 seats, the entertainment network of the present invention and the corresponding method for transmitting data offer significant advantages.

The following is a detailed description of four embodiments of the invention with reference to the Figures.

In the Figures:

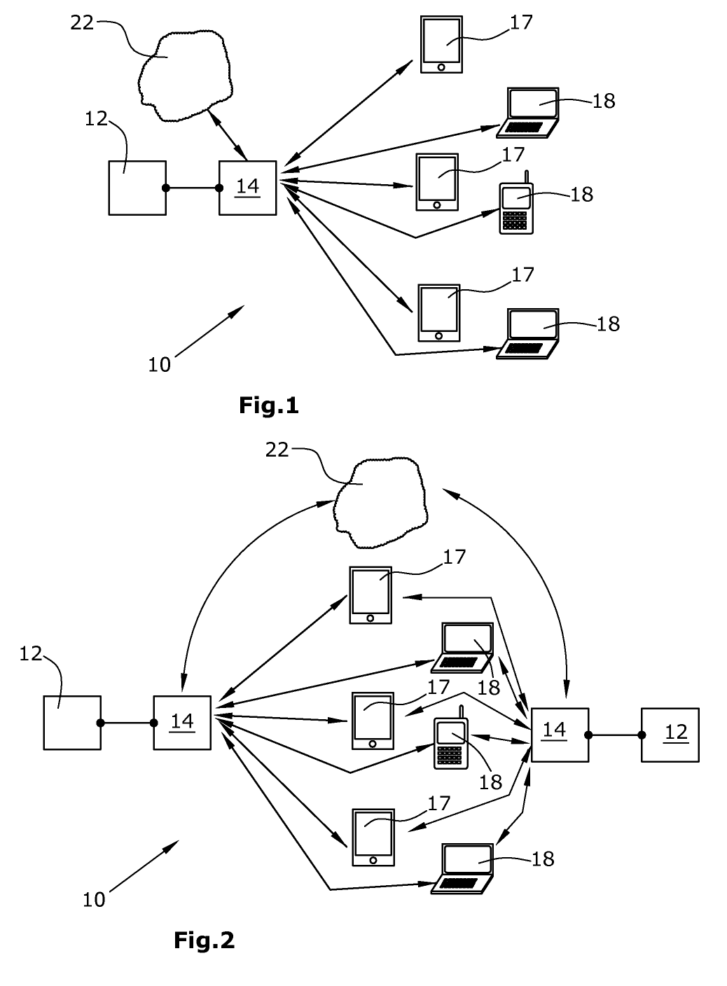

FIG. 1 shows a schematic illustration of a first embodiment of the entertainment network,

FIG. 2 shows a schematic illustration of a second embodiment of the entertainment network,

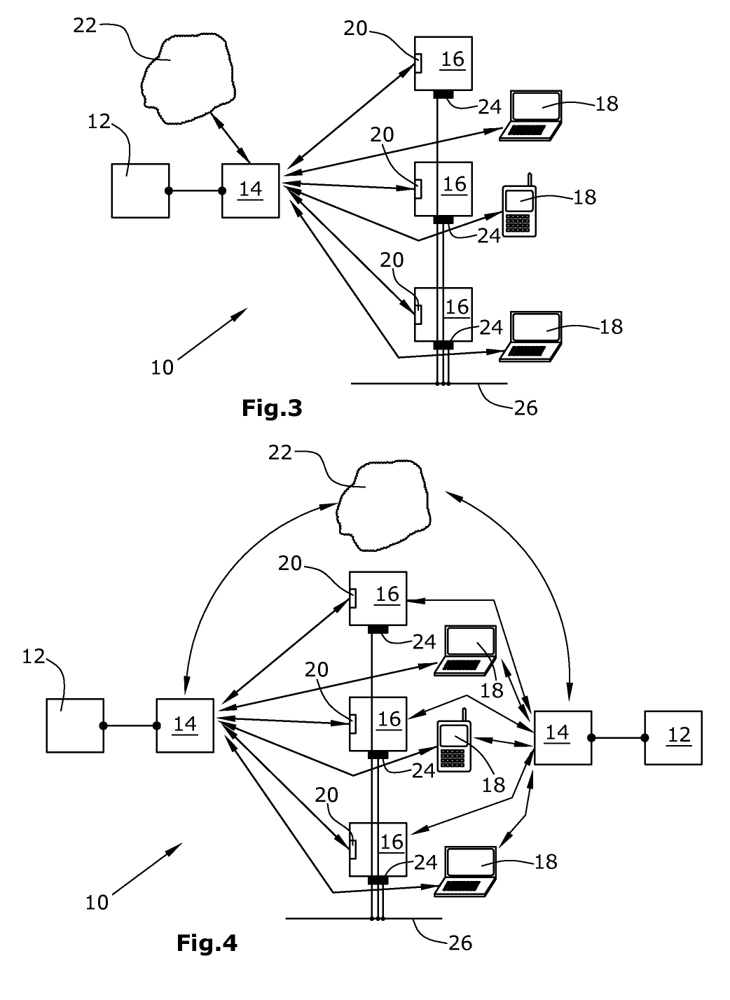

FIG. 3 shows a schematic illustration of a third embodiment of the entertainment network, and

FIG. 4 shows a schematic illustration of a fourth embodiment of the entertainment network.

FIG. 1 illustrates a first embodiment of the entertainment network 10 of the present invention. The entertainment network 10 includes a data server 12 on which audio and video data are available in a stored form. The audio data may exist in the form of individual pieces of music, individual music albums of different performers or playlists for the sequential playback of a plurality of different pieces of music in the manner of a radio program. Typically, the video data are movies, films or the like with associated audio data.

A routing means 14 is connected to the data server 12 via a conventional network cable link. The routing means 14 serves for the wireless broadband data transmission of the data on the server within the aircraft cabin. For this purpose, the routing means is designed as a WLAN access point and includes a corresponding WLAN router.

Each routing means 14 is configured to automatically establish a wireless radio link to playback devices 17 in the form of tablet PCs and with passenger terminals 18 for the purpose of broadband data transmission. Each tablet PC has a touchscreen for operating the same and is lent to a passenger at the beginning of a flight for the duration of the flight.

The embodiment in FIG. 3 differs from the embodiment in FIG. 1 in that the playback device 16 is not a tablet PC or another portable computer, but is fixedly allocated to a passenger seat. Here, each playback device 16 comprises a seat monitor (In-seat monitor) that is fixedly installed in a passenger seat. Further, each playback device 16 comprises a communication means 20 that establishes and maintains the radio link to the routing means 14 (WLAN access point).

Today, a large number of passengers carries an own individual passenger terminal 18 in the form of a notebook, a cell phone or a PDA (Personal Digital Assistant). These devices are typically configured to automatically establish WLAN radio links according to international standards, in order to establish a wireless radio data link in a home network or an Internet café, for example, using a WLAN router provided there, the link enabling access to the Internet or the transmission and receipt of e-mails. In order to be able to use passenger terminals 18 to receive video/audio data also in an aircraft, the routing means 14 offers the possibility of WLAN link to its WLAN router. The WLAN router is configured according to IEEE standard 802.11n and thus allows broadband data transmission in the form of data streams to a plurality of passenger terminals in a mutually independent manner. Moreover, the routing means 14 is connected to the World Wide Web 22. Thus, each passenger has the possibility to establish a link to the data server 12 via his notebook, cell phone or PDA in order to receive and play back the stored films or audio data as a data stream on his own terminal 18. As an alternative or in addition, a link to the World Wide Web 22 can be established via the routing means 14 in order to surf in the Internet or to send and receive e-mails.

In the 5 GHz frequency band, the WLAN standard 802.11n uses the frequencies in the range from 5.15 to 5.35 GHz and in the range from 5.47 to 5.475 GHz. Each passenger can use his terminal 18 to establish a wireless radio link to the routing means 14 and call films or music as desired from the data server according to the video-on-demand principle.

In order to prevent defective passenger terminals 18 from affecting the data transmission from the data server 12 to the seat monitors, the data transmission between the routing means 14 and the communication means 20 of the playback devices 16, 17 uses another frequency band that prevents crosstalk with the WLAN link to the passenger terminals 18. The frequency band provided for data transmission to the playback devices 16, 17 is an ISM (Industrial Scientific and Medical) band for use by high-frequency devices in the fields of industry, science and medicine, in the domestic and similar fields. The ISM frequency band used in the embodiments is in the range between 5.725 and 5.875 GHz. In addition, conventional so-called Intrusion Detection, Quality of Service and Bandwidth Management are used to enable stability and security of communication between the data server 12 and the playback devices 16, 17. Thereby, possible intentional attacks by passenger terminals 18 against the data link to the playback devices 16, 17 are also prevented.

Each playback device 16 in FIG. 3 is connected with a voltage supply network 26 integrated in the floor of the aircraft cabin, the connection being made though a quick connector 24 in the form of a busbar between the passenger seat and the floor of the aircraft cabin. As an alternative, it is also conceivable that the quick connector 24 provides a detachable connection between the display device and the passenger seat. The voltage supply of each seat monitor and of each communication means 20 is thus effected through the conventional on-board electrical system and independently of the wireless data link. The busbar allows a simple installation and removal of each passenger seat and thereby enables a flexible arrangement of the passenger seats and a change in the seat arrangement in the aircraft cabin. Due to the wireless data link between the routing means 14 and the communication means 20, the cables otherwise necessary for this data link can be omitted, resulting in a reduction of weight and a reduced risk for cable fires. The possibility of a flexible arrangement of the passenger seats is not affected.

The components of the embodiment in FIG. 2 and their functions and actions correspond to those of the embodiment in FIG. 1. The following is an explanation of the differences between the second embodiment and the first embodiment:

In the embodiment of the entertainment network 10 in FIG. 2, two routing means 14 and two data servers 12 are provided. The same video and audio data are stored on each data server 12, each data server 12 being connected with exactly one routing means 14 via data cables. Each of the two routing means 14 makes it possible to establish wireless data links to the playback devices 17 and to the passenger terminals 18 in the same frequency band, respectively. The decision which playback device 17 and which passenger terminal 18 establishes a radio link to which of the two routing means 14, is made according to the signal strength of the transmission/receiving signal. In other words: a playback device 17 and a passenger terminal 18 make a connection with that routing means 14 with which the highest signal quality is achieved for a radio link. As the number of routing means 14 is higher than in the first embodiment, a correspondingly greater number of passengers can be supplied with the data on the servers 12. In this manner, it is possible even in modern wide-body jets with 600 passenger seats that each passenger can call the same video/audio data.

The embodiment in FIG. 4 corresponds to that in FIG. 2 except for the playback devices 16. The playback devices 16 in FIG. 4 correspond to those in FIG. 3 having a seat monitor.

1. An entertainment network for passengers in a means of transportation, comprising
at least one data server for video and/or audio data,
at least one routing means connected with the data server,
at least one playback device for playing back the video/audio data,
the device being provided to a passenger on a lending basis for the duration of a trip,
wherein
the routing means is configured for a wireless broadband transmission of the video/audio data to at least 20, preferably at least 60 participants at the same time and in at least two different frequency bands independently of one another,
the playback device is configured for a wireless communication with the routing means,
the playback device being configured to only receive the data of a first frequency band and a second frequency band, which is different from the first band, being configured such that it is received only by individual passenger terminals such as notebooks, tablet PCs, PDAs etc., for example.

2. The entertainment network of claim 1, wherein the routing means is configured for communication with the World Wide Web.

3. The entertainment network claim 1, wherein the playback device is fixedly allocated to a passenger seat and comprises a seat monitor supported by a passenger seat, the playback device preferably being connected with a voltage supply network in the floor of the aircraft cabin via a quick connector.

4. The entertainment network of claim 1, wherein the playback device is a portable computer and preferably a tablet PC.

5. The entertainment network of claim 1, wherein the routing means comprises a broadband WLAN router according to IEEE standard 802.11n and is configured for radio transmission in an ISM frequency band.

6. The entertainment network of claim 4, wherein the playback device is configured for radio transmission in the ISM frequency band, for example between 5.1 and 5.5 GHz, and the first frequency band comprises a frequency range between 5.7 and 5.9 GHz.

7. A method for transmitting video and/or audio data in order to entertain passengers in a means of transportation, characterized by the steps of:
storing the video and/or audio data on at least one data server,
transmitting the video and/or audio data from the data server to at least one routing means for wireless broadband transmission,
wirelessly transmitting the video/audio data as a data stream in a first frequency band from the routing means to at least 20, preferably at least 60 playback devices for playing back the video/audio data on the playback device upon a request by a passenger, the playback devices being provided to passengers on a lending basis for the duration of a trip,
wirelessly transmitting video/audio data in a second frequency band, different from the first frequency band, from the routing means to at least one individual passenger terminal, such as a notebook, a tablet PC or a PDA, for example, for the purpose of storing the video/audio data on a passenger's terminal upon the passenger's request.

8. The method of claim 7, wherein the data server is able to distinguish each passenger terminal from a playback device and to transmit other video/audio data to a passenger terminal than to a playback device.

9. The method of claim 7, wherein the playback device is a portable computer and preferably a tablet PC.

10. The method of claim 7, wherein the passenger terminal and/or the playback device is connected upon demand through the device with the World Wide Web via the routing means.

11. The method of claim 7, wherein the playback device is fixedly allocated to a passenger seat and includes a seat monitor supported by a passenger seat, the playback device preferably being supplied with power from a voltage supply network in the floor of the aircraft cabin via a quick connector.

12. The method of claim 7, wherein the video/audio data are transmitted in the first frequency band by a broadband WLAN router of the routing means according to IEEE standard 802.11n, for example between 5.7 and 5.9 GHz.

13. The method of claim 7, wherein the second frequency band, in which the video/audio data are transmitted from the routing means to the individual passenger terminal, is an ISM frequency band, for example between 5.1 and 5.5 GHz.

14. The method of claim 7, wherein the video/audio data can be transmitted simultaneously and independently from each other to at least one playback device and at least one passenger terminal.

15. The method of claim 7, wherein a communication between a passenger terminal and each playback device is prevented.

16. The method claim 7, in wherein the data server is configured for transmitting and installing software programs on the devices, for example for playing back the audio/video data.
